(19) United States
(12) Patent Application Publication
(10) Pub. No.: US 2023/0156542 A1
(43) Pub. Date: May 18, 2023

(54) Cellular Network Which Selectively Configures a Measurement Gap Based on Subcarrier Spacing

(71) Applicant: Apple Inc., Cupertino, CA (US)

(72) Inventors: Yuqin Chen, Shenzhen (CN); Dawei Zhang, Saratoga, CA (US); Fangli Xu, Beijing (CN); Haijing Hu, Beijing (CN); Jie Cui, San Jose, CA (US); Yang Tang, San Jose, CA (US); Zhibin Wu, Los Altos, CA (US)

(21) Appl. No.: 17/916,918

(22) PCT Filed: Apr. 16, 2020
(86) PCT No.: PCT/CN2020/085012

§ 371 Date: Oct. 4, 2022

(51) Int. Cl. H04W 36/00; H04L 5/00

(52) U.S. Cl. CPC H04W 36/0088; H04L 5/0096

(57) ABSTRACT

A system for determining and reporting user equipment (UE) time gap requirement information for performing a measurement on a reference signal provided by a target base station. A UE receives a radio resource control (RRC) message from a current base station to modify a current RRC connection. The RRC configuration message may comprise sub carrier spacing (SCS) information of one or more target frequency bands of at least one target base station. The UE may then determine gap information based at least in part on the received SCS information of the one or more target frequency bands. The gap information may indicate whether a gap is needed in performing measurements on a reference signal transmitted at each of the one or more target frequency bands. The UE then transmits the gap information to the current base station.

### PRIORITY CLAIM

This application is a national phase entry of PCT application number PCT/CN2020/085012, entitled “Cellular Network Which Selectively Configures a Measurement Gap Based on Subcarrier Spacing,” filed Apr. 16, 2020, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD OF THE INVENTION

The present application relates to wireless networks for user equipment (UE) devices, and more particularly to a system and method for dynamically providing measurement gaps for use in target cell measurements.

### DESCRIPTION OF THE RELATED ART

Wireless communication systems have rapidly grown in usage. In recent years, wireless devices such as smart phones and tablet computers have become increasingly sophisticated. Mobile devices (i.e., user equipment devices or UEs) support telephone calls as well as provide access to the Internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH, etc.

In cellular network systems, when UE handover or cell reselection is occurring, the UE may perform a measurement on a reference signal provided by the target cell to assess the quality of the channel. When the reference signal transmitted by the target cell is at a different frequency than the frequency of the UE's current serving cell, the UE may request a gap, e.g., a time slot for performing the measurement. Presently, a UE reports a measurement gap requirement, or in other words requests a gap from the network (it's “need for gap”) based only on the current configured band combination. However, this method may be inadequate as it does not address other situations where a gap may be needed, and it may result in providing gaps at times when they are not actually needed. Therefore, improvements in the field are desired.

### SUMMARY OF THE INVENTION

Embodiments are presented herein of a system and method for operation of a base station and a UE to selectively configure a gap for a UE measurement of a target base station reference signal. The user equipment (UE) may comprise at least one antenna, a radio operably coupled to the at least one antenna for communicating with a cellular network, a memory which stores an application, and a processor operably coupled to the radio.

A serving (or current) base station may provide a message to a UE to modify or resume a current RRC connection. The message may take the form of a radio resource control (RRC) reconfiguration message or a radio resource control (RRC) resume message. The RRC message may comprise target band frequency information as well as sub carrier spacing (SCS) information of the target frequency band(s) of one or more target base stations. The RRC message may comprise other information as well, such as a band configuration of the current base station.

The UE may then determine gap information based at least in part on the target band frequency information and the received SCS information of the target frequency band(s). The gap information may indicate whether a gap is needed in performing measurements on a reference signal transmitted at each of the one or more target frequency bands. For each target band, the UE may determine the gap information based at least in part on one or both of the frequency of the target band and the received SCS information of the target band.

As one example, if the frequency of the target band and the serving band are the same, the UE may determine “gap” or “no gap” based on the difference in subcarrier spacing between the target band and the serving band. As another example, if the received SCS information on a first target band is the same as that of the current base, the UE may specify “no gap” for the first target band in some instances. If the received SCS information indicates a first SCS on a first target band, and the current base station has a second different SCS, the gap information may indicate a gap for the first target band in some instances.

The UE then transmits the gap information to the current base station. The gap information may be useable by the base station in determining whether to allocate a time slot to the UE for performing a measurement of a reference signal at each of the target frequency bands.

In another embodiment, the RRC message may comprise target carrier band configuration information of one or more target frequency bands, but may not include any SCS information. In this embodiment, the determined gap information may be based at least in part on an assumption that the respective target frequency band has an SCS configuration that is the same as the current base station SCS configuration. The UE may then transmit the gap information to the current base station. The base station may override the gap information received from the UE in instances where the assumption made by the UE is not correct, i.e., the SCS configuration of the target band is not the same as the SCS of the current configuration. In another embodiment, the UE may provide gap information to the base station along with an assumed subcarrier spacing used in making the determination. The base station can then compare the assumed SCS received by the UE with the actual SCS of the target band and selectively override the UE's “no gap” indication where the two SCS values differ.

Note that the techniques described herein may be implemented in and/or used with a number of different types of devices, including but not limited to base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present invention can be obtained when the following detailed description of the embodiments is considered in conjunction with the following drawings.

FIG. 1 illustrates an example (and simplified) wireless communication system according to some embodiments;

FIG. 2 illustrates an example of a base station (BS) and an access point in communication with a user equipment (UE) device according to some embodiments;

FIG. 3 is a block diagram of a cellular network system, according to some embodiments;

FIG. 4 illustrates an example block diagram of a UE, according to one embodiment;

FIG. 5 illustrates an example block diagram of a base station, according to one embodiment;

FIG. 6 illustrates an example of channel bandwidth;

FIG. 7 is a flow diagram illustrating a method where the network transmits sub carrier spacing information of target bands for use by the UE in determining Need for Gap Information, according to some embodiments;

FIG. 8 is a flow diagram illustrating a method where the UE transmits Need for Gap Information to the network based on an assumption that the sub carrier spacing on the target carrier is the same, according to some embodiments; and

FIG. 9 is a flow diagram illustrating a method where the UE transmits Need for Gap Information to the network for each target band and for each sub carrier spacing, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Acronyms

Various acronyms are used throughout the present disclosure. Definitions of the most prominently used acronyms that may appear throughout the present disclosure are provided below:
UE: User Equipment
RF: Radio Frequency
BS: Base Station
NW: Network
DL: Downlink
UL: Uplink
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
FDMA: Frequency Division Multiple Access
OFMDA: Orthogonal Frequency Division Multiple Access
SCS: Sub Carrier Spacing
SSB: Synchronization Signal Block
CSI-RS: Channel State Information—Reference Signal
BC: Band Configuration
IE: Information Element
NF: Network Function
PUSCH: Physical Uplink Shared Channel
PDCCH: Physical Downlink Control Channel
RRC: Radio Resource Control

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™ Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, unmanned aerial vehicles (UAVs), unmanned aerial controllers (UACs), vehicles, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

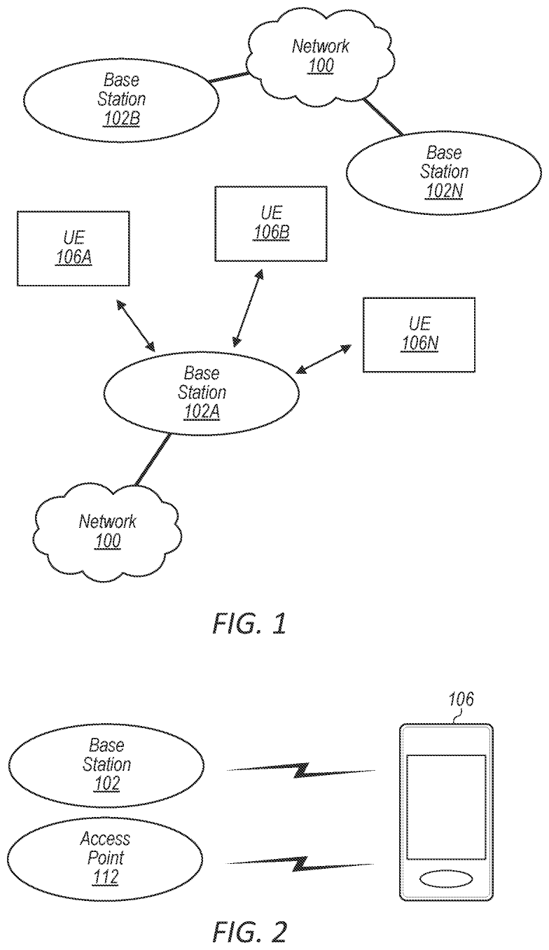

### FIGS. 1 and 2—Example Communication System

FIG. 1 illustrates a simplified example wireless communication system in which aspects of this disclosure may be implemented, according to some embodiments. It is noted that the system of FIG. 1 is merely one example of a possible system, and embodiments may be implemented in any of various systems, as desired.

As shown, the example wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices. The UE devices are examples of wireless devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’.

The communication area (or coverage area) of the base station may be referred to as a “cell.” The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. In particular, the cellular base station 102A may provide UEs 106 with various telecommunication capabilities, such as voice, SMS and/or data services.

As also used herein, from the perspective of UEs, a base station may sometimes be considered as representing the network as far as uplink and downlink communications of the UE are concerned. Thus, a UE communicating with one or more base stations in the network may also be interpreted as the UE communicating with the network.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment (UE) 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device as defined above.

The UE 106 may include a processor (processing element) that is configured to execute program instructions stored in memory. The UE 106 may perform any of the operations described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the embodiments described herein, or any portion of any of the embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

In a similar manner, the base station 102 may include a processor (processing element) that is configured to execute program instructions stored in memory. The base station 102 may perform any of the operations described herein by executing such stored instructions. Alternatively, or in addition, the base station 102 may include a programmable hardware element such as an FPGA (field-programmable gate array), an integrated circuit, and/or any of various other possible hardware components that are configured to perform (e.g., individually or in combination) any of the embodiments described herein, or any portion of any of the embodiments described herein.

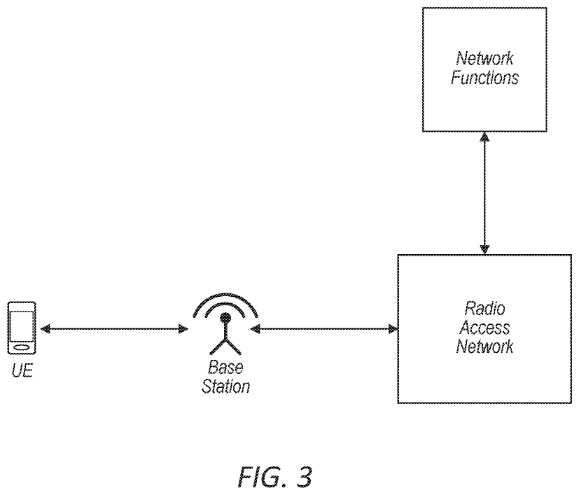

### FIG. 3—Example Cellular Network

FIG. 3 is a block diagram illustrating an example cellular network, according to some embodiments. As shown, the UE communicates in a wireless fashion with a base station, which may as one example be referred to as gNB. The base station in turn communicates to a cellular network.

FIG. 3 illustrates a simplified view of a cellular network, showing various elements which may be relevant to operations described herein. As shown, the base station may couple to a Radio Access Network (RAN). The RAN may in turn couple to various network elements or network functions, e.g., one or more computer systems which implement various network functions. For example, the Radio Access Network may couple to a User Plane Function (UPF) which in turn may be coupled to various additional network functions.

Typically, Network Functions may be implemented as software executing on a computer system, such as a server, e.g., a cloud server. Network functions which may be present in the cellular network system may include functions such as an Access and Mobility Management Function (AMF), a Policy Control Function (PCF), a Network Data Analytics Function (NWDAF), an Application Function (AF), a Network Slice Selection Function (NSSF), and a UE radio Capability Management Function (UCMF), among numerous possible others.

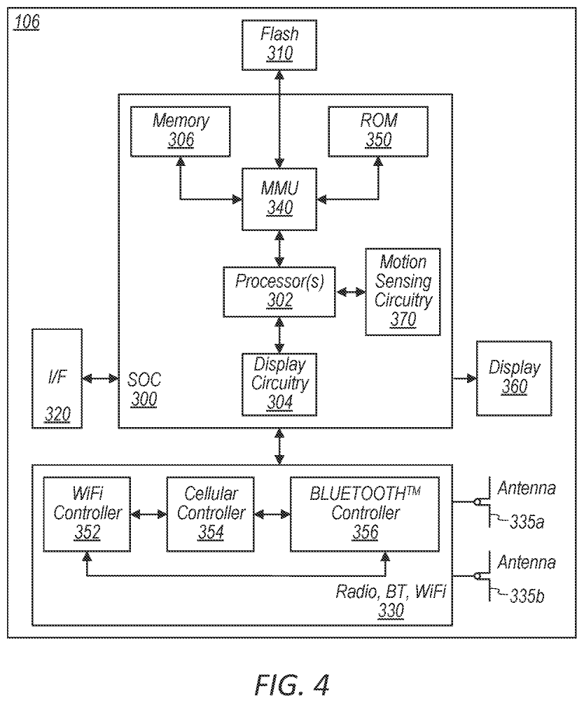

### FIG. 4—Block Diagram of an Example UE Device

FIG. 4 illustrates a block diagram of an example UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include motion sensing circuitry 370 which may detect motion of the UE 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, Flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

In some embodiments, radio 330 may include separate controllers dedicated to controlling communications for various respective RAT standards. For example, as shown in FIG. 4, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

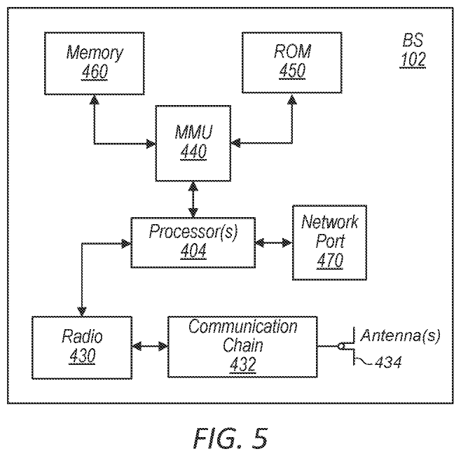

### FIG. 5—Block Diagram of an Example Base Station

FIG. 5 illustrates a block diagram of an example base station 102, according to some embodiments. It is noted that the base station of FIG. 5 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). In the case of certain RATs, for example Wi-Fi, base station 102 may be designed as an access point (AP), in which case network port 470 may be implemented to provide access to a wide area network and/or local area network (s), e.g. it may include at least one Ethernet port, and radio 430 may be designed to communicate according to the Wi-Fi standard.

### Measurement Gaps

Cellular devices are in wide use globally, and are commonly used in transit, resulting in the movement of a UE from one geographical cell to another. This movement often requires the UE to perform a handover, i.e., to transfer its communications from one (serving) base station to another (target) base station. For example, when a user is driving down a highway, the user's UE may leave a first cell of a network and enter a second cell. This may cause the UE to perform a handover, where it discontinues communication with a first base station of the first (serving) cell and begins to communicate with a second base station of the second (target) cell. A UE may also perform a cell reselection when in idle mode to attempt to connect to a cell with the best signal quality.

When the UE desires to perform a handover (or reselection) to a new target cell, the UE may perform a measurement on a reference signal provided by the base station of the new cell to assess the quality of the channel between the UE and the cell. The measurement performed by a UE on a target cell reference signal may produce channel state information (CSI) which characterizes the quality of the channel. The UE may report this channel state information back to the network, so that the network can decide whether or not to allow the UE to handover (or reselect) to this target cell.

However, various problems may arise when the UE attempts to perform a measurement on the reference signal of a new target cell. For example, the base station of the target cell may use a different carrier frequency when communicating with the UE than the current serving cell. The term “intra-frequency measurement” refers to a situation where the current serving cell and the target cell operate on the same carrier frequency and the same SCS is applied on the serving and target cell. The term “inter-frequency measurement” refers to a situation where the current serving cell and the target cell operate on a different carrier frequency or where the current serving cell and the target cell operate on the same carrier frequency but with different SCS.

In some cases, the UE may request the network to configure at least one “measurement gap” so that the UE can perform measurements on the target carrier. As used herein, the term “measurement gap” or “gap” has the full extent of its ordinary meaning and at least refers to an amount of time, such as a time slot, allocated to the UE to perform a desired measurement. The concept of a “measurement gap” is to create a small gap in time during which no transmission and reception occurs. Since there is no signal transmission and reception during the gap, the UE can switch its RF chain to the frequency of the target cell and perform the signal quality measurement and then return to the frequency of the current serving cell.

For example, when the UE attempts to perform an inter-frequency measurement, i.e., a measurement on a reference signal transmitted at a different frequency than that of its current serving cell, the UE may need additional time to configure its radio (receive chain) to the new frequency. In other words, the UE may need extra time to measure a reference signal at the target carrier frequency while it is transmitting/receiving on the serving cell at a different frequency, and hence the UE may request a measurement gap. Similarly, when the UE attempts to perform a measurement on a target cell operating according to a different radio access technology (RAT) than its current serving cell, the UE may need extra time for this as well. Thus, the UE may need measurement gaps to identify and/or measure inter-frequency or inter-RAT cells.

Some UE's have multiple RF chains, such as multiple receive chains, and thus may operate such that a first RF chain communicates with the current serving cell while a second RF chain is configured to perform a measurement of a target cell operating at a different carrier frequency. However, sometimes multiple instances of an RF chain may be occupied, e.g., a first RF chain may be used for performing voice communication (a phone call), and a second RF chain may be simultaneously used for data communication, such as downloading email. In this instance, a measurement gap may also be desired.

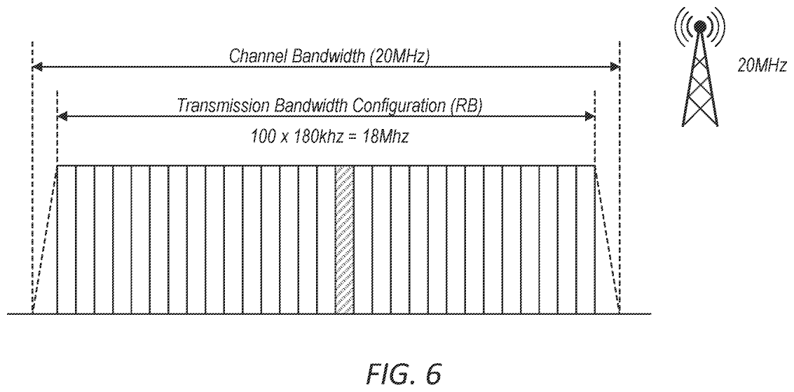

In radio access networks (RANs), the overall channel bandwidth is divided up into a plurality of subcarriers. The term “subcarrier” may refer to a portion or all of a carrier wave, such as a sideband of a carrier wave, that is modulated to send information. FIG. 6 illustrates a simple example of LTE channel bandwidth having a plurality of subcarriers. The number of subcarriers in a channel may depend on the channel bandwidth, where the number of subcarriers typically increases with increasing channel bandwidth. RF subcarriers may have various different parameters, such as subcarrier spacing. The phrase “subcarrier spacing” refers to the spacing allocated for subcarriers, and subcarrier spacing may also be referred to as the “symbol time”. In the proposed New Radio (NR) standard, the NR subcarrier spacing is defined as 15×2ⁿ kHz, where n can currently take positive values and in the future may take negative values as well, as follows:

n=0, 15×2⁰=15 kHz

n=1, 15×2¹=30 kHz

n=2, 15×2²=60 kHz

n=3, 15×2³=120 kHz

n=4, 15×2⁴240 kHz

n=−1, 15×2⁻¹=7.5 kHz

n=−2, 15×2⁻²=3.75 kHz

Embodiments described herein may provide that the UE may take into account the subcarrier spacing of one or both of the serving cell and the target cell in determining whether to request a measurement gap. More specifically, in some embodiments the determination of whether a gap is needed may depend on: 1) the target band frequency (the frequency location of the target band), where the UE may or may not have an extra RF chain to measure the particular frequency; and 2) the SCS of the target band frequency.

In some cases, the UE may be able to measure a target band at the same time it conducts transmission with its serving cell when the SCS of the target cell and the serving cell are the same. The typical case is when the reference signal has a target band frequency that is inside/or near the active bandwidth part on the serving cell. In this case, the UE may use one RF chain to perform both of these operations at the same time.

Thus, in some embodiments, both the target band frequency and the SCS of the target band may be evaluated in determining a need for a gap. For example, for each target band the UE may report a separate UE capability or gap information, which may be at least partially dependent on (or may consider) the subcarrier spacing of the target band. The gap information may consider other factors as well, such as target band frequency and/or available radio frequency (RF) resources of the UE. For example, for one target band with the same SCS as the serving cell, the UE could report “no gap”. In contrast, for a second target band with same SCS as the serving cell, the UE may report “gap is needed”. In addition, for a target band with a different SCS from the serving cell, the UE could report “no gap” if the UE has an extra RF chain for that band. For another target band with a different SCS than the serving cell, the UE could report “gap is needed” if no extra RF chain is available.

The following describes the operation of various possible embodiments. As described below, the UE (or the network) may compare the subcarrier spacing of the current serving cell and the target cell (i.e., compare the subcarrier spacing of a serving band of the serving cell and a target band of the target cell) to help determine whether a measurement gap should be requested.

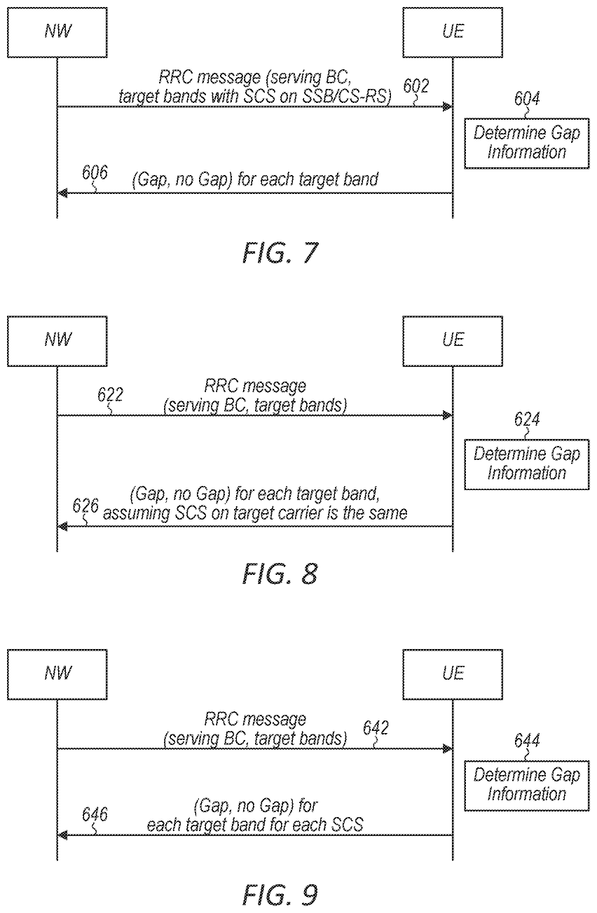

### FIG. 7

FIG. 7 is a flow diagram illustrating operation of a base station and a UE selectively configuring a gap for a UE measurement of a target base station reference signal.

As shown at 602, the serving base station (BS) may send a message, such as a radio resource control (RRC) message, to a UE. The RRC message may be in the form of a Radio Resource Control (RRC) Reconfiguration message or an RRC resume message. The RRC message may comprise serving cell band configuration (BC) information, target carrier band configuration information and subcarrier spacing (SCS) information of the respective target bands. More particularly, the RRC message may comprise information regarding a plurality of target bands and SCS information for each of the target bands. The term “target band” refers to the frequency or carrier used by a target cell (or target base station). For each target band, the subcarrier spacing information may be associated with a reference signal provided by the target base station in the target cell. The reference signal may take the form of a Synchronization Signal Block (SSB) or a Channel State Information—Reference Signal (CSI-RS).

At 604 the UE may receive this information and use it to determine whether it will request a measurement gap for at least one target band (preferably each target band). For example, the UE may already have knowledge of the SCS of its current serving cell (the base station or cell to which the UE is currently camped). At 602 the UE receives information regarding the frequencies of one or more target bands and the SCS of each of the one or more target bands. At 604 the UE may, for each received target band, use the frequency of the respective band and its corresponding SCS to determine whether a gap should be requested for the respective target band. The UE may use other information as well in determining gap information, such as available UE RF resources, etc.

In some embodiments, if the SCS of the serving cell matches the SCS of a respective target band, then the UE may indicate that no gap is desired for that respective target band (dependent on other factors). This may occur when the reference signal of the target band is within or proximate to the active bandwidth part (BWP) of the serving band. Conversely, if the SCS of the serving cell does not match the SCS of a respective target band, then the UE may indicate that a gap is desired for that respective target band. Thus, for one target band with the same SCS as the serving cell, the UE could report “no gap”, if, e.g., the reference signal of target band frequency is very close to, or within, the active bandwidth part (BWP) of the serving cell. For a second target band with same SCS as the serving cell, the UE may report “gap is needed”, if, e.g., the reference signal of target band frequency is not close to or within the bandwidth part (BWP) of the serving cell and no additional UE RF resources are available.

At 606 the UE reports gap information to the base station. The gap information may comprise the “needforgap” for each of the target bands received in the reconfiguration message at 602. More specifically, the gap information provided at 606 may indicate “gap” or “no gap” for each of the target bands. In some embodiments the UE generates a reply message that it transmits in the Physical Uplink Control Channel (PUCCH) to the base station. The gap information may be provided by the UE to the base station using the RRCreconfigurationcomplete message or the RRCresumecomplete message.

The base station (or the network) may then use this information to selectively provide a gap (e.g., a time slot) to the UE, as requested by the UE, in order for the UE to perform a measurement on a reference signal of the respective target base station (the target base station associated with the target band). For example, if the UE requests a gap for a first target band, the base station may provide a gap (a measurement gap) to the UE for performing a measurement on the target base station reference signal associated with the target band.

### FIG. 8

FIG. 8 is a flow diagram illustrating another embodiment of operation of a base station and a UE selectively configuring a gap for a UE measurement of a target base station reference signal.

As shown at 622, a serving BS sends an RRC message to a UE. The RRC information may comprise serving band configuration information and information associated with one or more target bands, e.g., target carrier band configuration information. In this embodiment, the RRC information does not include subcarrier spacing information (SCS) of target bands. As noted above, the RRC message may be in the form of a RRC reconfiguration message or an RRC resume message.

At 624 the UE may receive this information and use it to determine whether it will request a measurement gap for at least one band (preferably each target band). For example, the UE may already have knowledge of the SCS of its current serving cell (the base station or cell to which the UE is currently camped). At 622, the UE does not receive information regarding the SCS of one or more target bands. Therefore, in this embodiment the UE may make the assumption that the SCS configuration of each target band is the same as the SCS configuration of the serving carrier (of the serving cell or serving base station) and determine its need for measurement gaps accordingly. Thus, if the target band frequency is different from the serving carrier, the UE may request a gap. If the target band frequency of the reference signal is close to or within the active bandwidth part (BWP) of the serving carrier, the UE may not request a gap.

At 626, the UE reports its measurement gap requirements for each target band to the base station. The base station may then use this information to selectively provide a gap (e.g., a time slot) to the UE, possibly as requested by the UE. As discussed above, the provision of a gap by the base station may allow the UE to perform a measurement on a reference signal of a target base station. More particularly, when the base station determines that the actual SCS configuration of the target carrier is different from the serving carrier, the network may determine that a gap is needed (regardless of the nature of the UE gap information). Thus, here when the base station determines that the presumption made by the UE is incorrect (that in fact the SCS of the target carrier does not match that of the serving carrier), the base station essentially overrides the gap information of the UE. Thus if the UE had specified “no gap” based on the assumption that the SCS of the target carrier matches that of the serving carrier, but in fact they do not, the base station may ignore the “no gap” information provided by the UE and provide a gap to the UE for the reference signal measurement. However, if the UE reports “gap”, the base station may provide a gap to the UE regardless of whether or not the base station determines that the presumption made by the UE is incorrect.

When the base station determines that the actual SCS configuration of the target carrier matches the presumption made by the UE (is the same as the serving carrier), and the UE has requested “no gap”, the network may determine that no gap is needed. Similarly, when the base station determines that the actual SCS configuration of the target carrier matches the presumption made by the UE (is the same as the serving carrier), and the UE has requested a gap, the network may determine that a gap is needed.

Thus, the base station, having knowledge that the SCS configuration of each target band was not sent to the UE, may independently determine whether a measurement gap is needed for each target band. If the base station determines that the SCS configuration of the target carrier is different from that of the serving carrier, the base station may determine that a gap is needed, regardless of the gap information provided by the UE.

### FIG. 9

FIG. 9 is a flow diagram illustrating operation of another embodiment of a base station and a UE selectively configuring a gap for a UE measurement of a target base station reference signal.

As shown at 642, a serving base station may send RRC information (e.g., an RRC message) to a UE. The RRC information may comprise serving band configuration information and information associated with one or more target bands, e.g., target carrier band configuration information. In this embodiment, the RRC information does not include subcarrier spacing information (SC S) of target bands.

At 644 the UE may receive this information and use it to determine whether it will request a measurement gap for each target band. This determination may be based on an assumed target carrier sub carrier spacing. As noted above, at 642 the UE does not receive information regarding the SCS of one or more target bands. Thus, since here the UE has no knowledge of SCS information for various target bands, the UE determines gap information for at least one possible SCS value associated with each target band.

At 646 the UE may report its measurement gap requirements for each target band to the base station as well as the assumed SCS that was used in determining the associated measurement gap requirement. Stated another way, the UE may report to the base station a combination of the gap requirement associated with each target band and the assumed target band SCS used in determining the gap requirement. In other words, the UE may make at least one assumption about the SCS of each one or more target bands and report the assumed SCS configuration(s) to the base station.

The base station (or the network) may then use this information to selectively provide a gap (e.g., a time slot) to the UE, as requested by the UE, in order for the UE to perform a measurement on a reference signal of a target base station.

In an embodiment where the UE has two or more RF chains, the UE may send SCS information associated with the specific RF chain it may plan to use to perform the measurement. Since here the base station does not know which RF chain the UE will use for the measurement, the UE may provide this information to the base station.

For example, assume a UE has three RF chains and is configured to communicate with three serving carriers, where each serving carrier has a different SCS. The UE may re-use one of these RF chains to perform inter-frequency measurement, however the base station does not know which one a priori. Thus, in this embodiment the UE may provide either assumed SCS information of a target base station, or SCS information associated with the relevant RF chain that will be doing the measurement (the SCS information of the serving channel in which the relevant RF chain is in communication). The base station (the network) is already fully aware of the SCS of each target carrier. With this information from the UE regarding an assumed target SCS, or the SCS of the relevant serving channel, the network can make a proper configuration.

As noted above, the base station may be fully aware of the SCS of each target band. If the UE has requested “no gap” for a target band, and the UE has reported an assumed SCS that is not in fact used on the target band, the base station may determine that a gap is needed, overriding the request of the UE. If the UE has requested a gap for a target band but has not provided the base station with the assumed SCS used by the UE to determine its gap requirements, the network will determine that a gap is needed.

Embodiments are described herein in the context of cellular systems (e.g., 3GPP-based systems). However, the embodiments described herein may be readily extended to non-cellular (non-3GPP-based) systems, such as Wi-Fi systems.

Embodiments of the present invention may be realized in any of various forms. For example, in some embodiments, the present invention may be realized as a computer- implemented method, a computer-readable memory medium, or a computer system. In other embodiments, the present invention may be realized using one or more custom- designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

It is well understood that the use of personally identifiable information should follow privacy policies and practices that are generally recognized as meeting or exceeding industry or governmental requirements for maintaining the privacy of users.

In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus, comprising:
at least one processor configured to cause a user equipment (UE) to:
receive a radio resource control message from a current base station to modify a current radio connection, wherein the radio resource control message comprises subcarrier spacing information of one or more target bands of at least one target base station;
determine gap information based at least in part on a frequency of the one or more target bands and the received subcarrier spacing information of the one or more target bands, wherein the gap information indicates whether a gap is needed in performing measurements on a reference signal transmitted at each of the one or more target frequency bands; and
transmit the gap information to the current base station.

2. The apparatus of claim 1,
wherein, in determining the gap information, the at least one processor is configured to cause the UE to determine if the subcarrier spacing information of at least one target band matches subcarrier spacing information of a serving band of the current base station.

3. The apparatus of claim 1,
wherein the radio resource control message comprises subcarrier spacing information of a plurality of target bands;
wherein the at least one processor is configured to cause the UE to determine gap information for each of the plurality of target bands;
wherein the gap information indicates whether a gap or no gap is needed for each of the plurality of target bands.

4. The apparatus of claim 1,
wherein, for at least one target band, the at least one processor is configured to cause the UE to determine the gap information based at least in part on available radio frequency (RF) resources of the UE.

5. The apparatus of claim 1,
wherein a first target band has a reference signal of target band frequency that is inside or near an active bandwidth part of a serving band of the current base station;
wherein the at least one processor is configured to cause the UE to determine that no gap is needed for the first target band if the subcarrier spacing of the target band is the same as the subcarrier spacing of the serving band of the current base station.

6. The apparatus of claim 5,
wherein the at least one processor is configured to cause the UE to determine that a gap is needed for the first target band if the subcarrier spacing of the target band is different from the subcarrier spacing of the serving band of the current base station.

7. The apparatus of claim 1,
wherein the subcarrier spacing information in the received radio resource control message indicates a first subcarrier spacing on a first target band;
wherein a serving band of the current base station also has the first subcarrier spacing;
wherein the gap information determined by the UE indicates no gap for the first target band.

8. The apparatus of claim 1,
wherein the sub carrier spacing information in the received radio resource control message indicates a first subcarrier spacing on a first target band;
wherein a serving band of the current base station has a second different subcarrier spacing;
wherein the gap information determined by the UE indicates a gap for the first target band.

9. The apparatus of claim 1,
wherein the gap information is useable by the current base station in determining whether to allocate a time slot to the UE for performing a measurement of a reference signal at each of the one or more target frequency bands.

10. The apparatus of claim 1,
wherein the radio resource control message further comprises information regarding a band configuration of the current base station;
wherein the at least one processor is configured to cause the UE to determine the gap information based at least in part on the band configuration of the current base station.

11. The apparatus of claim 1, further comprising:
a radio operably coupled to the at least one processor.

12. A cellular base station, comprising:
a plurality of antennas;
a radio operably coupled to the plurality of antennas; and
a processor operably coupled to the radio;
wherein the cellular base station is configured to:
transmit a radio resource control message to a user equipment (UE) to modify a current radio resource control (RRC) connection of the UE with the base station, wherein the radio resource control message comprises subcarrier spacing information of one or more target bands of at least one target base station;
receive gap information from the UE in response to transmission of the radio resource control message to the UE, wherein the gap information indicates whether a gap is needed in performing measurements on a reference signal transmitted at each of the one or more target frequency bands; and
selectively assign at least one time slot to the UE for target base station reference signal measurements based on the received gap information.

13. The cellular base station of claim 12,
wherein the gap information is determined based at least in part on the subcarrier spacing information of the one or more target frequency bands transmitted to the UE in the radio resource control reconfiguration message.

14-20. (canceled)

21. The cellular base station of claim 12, wherein the radio resource control message comprises target band configuration information of the one or more target bands of the at least one target base station.

22. The cellular base station of claim 12, wherein the cellular base station is further configured to:
receive respective gap information for each of the one or more target bands from the UE, wherein for each respective target band the respective gap information is based at least in part on an assumption that the respective target frequency band has a subcarrier spacing (SCS) configuration that is the same as the cellular base station SCS configuration, wherein for each respective target band the respective gap information indicates whether a gap is needed in performing measurements on a reference signal transmitted at the respective target frequency band.

23. The cellular base station of claim 22,
wherein the gap information indicates a gap for a first target band based in part on the assumption that the first target band has a SCS configuration that is the same as the cellular base station SCS configuration;
wherein the cellular base station is configured to not provide a gap for the first target band based on a determination the assumption is incorrect.

24. A method, comprising:
communicating with a current base station, wherein the current base station has a first subcarrier spacing (SCS) configuration;
receiving a radio resource control message from the current base station to modify a current radio connection, wherein the radio resource control message comprises target band configuration information of one or more target bands of at least one target base station;
determining gap information for each of the one or more target bands, wherein for each respective target band the gap information is based at least in part on an assumption that the respective target band has a SCS configuration that is the same as the first SCS configuration, wherein for each respective target frequency band the gap information indicates whether a gap is needed in performing measurements on a reference signal transmitted at the respective target frequency band; and
transmitting the gap information to the current base station.

25. The method of claim 24,
wherein the gap information is useable by the current base station in determining whether to allocate a time slot to a user equipment (UE) for performing a measurement of a reference signal at each of the one or more target bands.

26. The method of claim 24,
wherein the gap information indicates that no gap is needed for a first target band;
wherein the method further comprises:
receiving a measurement gap allocation when measuring a reference signal at the first target band when the first target band has a subcarrier spacing configuration different from the first subcarrier spacing configuration.

27. The method of claim 24,
wherein the radio resource control message comprises target band configuration information of a plurality of target bands of a plurality of target base stations, and wherein the method further comprises:
determining respective gap information for each of the plurality of target bands, wherein each determined respective gap information is based on a respective SCS configuration; and
transmitting the respective gap information and the first subcarrier spacing configuration to the current base station.

28. The method of claim 27,
wherein the respective gap information is useable by the current base station in determining whether to allocate a time slot to a user equipment (UE) for performing a measurement of a reference signal at each of the plurality of target frequency bands.
